(19) United States
(12) Patent Application Publication
(10) Pub. No.: US 2024/0413942 A1
(43) Pub. Date: Dec. 12, 2024

(54) REPEATER-ASSISTED COMMUNICATION

(71) Applicant: Lenovo (Singapore) Pte. Ltd., New Tech Park (SG)

(72) Inventors: Ahmed Hindy, Aurora, IL (US); Ali Ramadan Ali, Kraiburg am Inn (DE); Vijay Nangia, Woodridge, IL (US)

(21) Appl. No.: 18/697,106

(22) PCT Filed: Sep. 30, 2022
(86) PCT No.: PCT/IB2022/059364

§ 371 Date: Mar. 29, 2024

Related U.S. Application Data
(60) Provisional application No. 63/251,016, filed on Sep. 30, 2021.

(51) Int. Cl. H04L 5/00; H04B 7/06

(52) U.S. Cl. CPC H04L 5/0044; H04B 7/0626; H04L 5/0007

(57) ABSTRACT

Apparatuses, methods, and systems are disclosed for repeater-assisted communication. An apparatus (600) includes a processor (605) and a memory (610) coupled to the processor (605). In one embodiment, the processor (605) is configured to cause the apparatus (600) to receive, from a network, an indication of RAC for the apparatus (600): receive, from the network, configuration information comprising at least one of frequency resources and time resources that the apparatus (600) uses for RAC; receive, from the network, configuration information for reference signals that are transmitted from the network to the apparatus (600); and determine an indication of one or more UE devices whose transmissions are repeated by the apparatus (600).

### CROSS REFERENCE TO RELATED APPLICATIONS

This application claims the benefit of U.S. Provisional Patent Application No. 63/251,016, entitled “REPEATER-ASSISTED COMMUNICATION IN 5G NR” and filed on Sep. 30, 2021, for Ahmed Hindy, et al., which is incorporated herein by reference.

### FIELD

The subject matter disclosed herein relates generally to wireless communications and more particularly relates to repeater-assisted communication.

### BACKGROUND

In wireless networks, one of the biggest challenges in 5G new radio (“NR”) is extending the network coverage in both uplink and downlink communications.

### BRIEF SUMMARY

Disclosed are solutions for repeater-assisted communication in 5G NR. The solutions may be implemented by apparatus, systems, methods, or computer program products.

In one embodiment, a first apparatus includes a processor and a memory coupled to the processor. In one embodiment, the processor is configured to cause the apparatus to receive, from a network, an indication of RAC for the apparatus, receive, from the network, configuration information comprising at least one of frequency resources and time resources that the apparatus uses for RAC, receive, from the network, configuration information for reference signals that are transmitted from the network to the apparatus, and determine an indication of one or more UE devices whose transmissions are repeated by the apparatus.

In one embodiment, a first method receives, from a network, an indication of RAC for a repeater apparatus, receives, from the network, configuration information comprising at least one of frequency resources and time resources that the apparatus uses for RAC, receives, from the network, configuration information for reference signals that are transmitted from the network to the apparatus, and determines an indication of one or more UE devices whose transmissions are repeated by the apparatus.

In one embodiment, a second apparatus includes a processor and a memory coupled to the processor. In one embodiment, the processor is configured to cause the apparatus to transmit, to a repeater, an indication of RAC for the apparatus, transmit, to the repeater, configuration information comprising at least one of frequency resources and time resources that the apparatus uses for RAC, transmit, to the repeater, configuration information for reference signals that are transmitted from the repeater to the network, and transmit, to the repeater, an indication of one or more UE devices whose transmissions are repeated by the repeater.

In one embodiment, a second method transmits, to a repeater, an indication of RAC for the apparatus, transmits, to the repeater, configuration information comprising at least one of frequency resources and time resources that the apparatus uses for RAC, transmits, to the repeater, configuration information for reference signals that are transmitted from the repeater to the network, and transmits, to the repeater, an indication of one or more UE devices whose transmissions are repeated by the repeater.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for repeater-assisted communication in 5G NR;

FIG. 2 depicts synchronization signal block (“SSB”) beams grouping with the repeater presence;

FIG. 3 depicts a user equipment (“UE”) in the coverage of both transmit/receipt point (“TRP”) and repeater;

FIG. 4A depicts one example of handling interference from repeater on other UEs;

FIG. 4B depicts one example of handling interference from repeater on other UEs;

FIG. 4C depicts one example of handling interference from repeater on other UEs;

FIG. 4D depicts one example of handling interference from repeater on other UEs;

FIG. 5 is a diagram illustrating one embodiment of a NR protocol stack;

FIG. 6 is a block diagram illustrating one embodiment of a user equipment apparatus that may be used for repeater-assisted communication;

FIG. 7 is a block diagram illustrating one embodiment of a network apparatus that may be used for repeater-assisted communication;

FIG. 8 is a flowchart diagram illustrating one embodiment of a method for repeater-assisted communication; and

FIG. 9 is a flowchart diagram illustrating one embodiment of a method for repeater-assisted communication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for repeater-assisted communication in 5G NR. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

One of the biggest challenges in 5G NR is extending the network coverage in both uplink and downlink communication. One conventional solution to this problem is via densifying the network by implementing additional network transceiver nodes; however, the cost of such approach is extremely large. Another alternative is via introducing integrated access and backhaul (“IAB”) nodes to assist the network with improving the performance; however, this solution may also require very high implementation costs.

In this disclosure, a solution is proposed that uses repeater nodes, hereafter dubbed “repeaters” for brevity, to help densify the network, wherein the repeater, with the help of side control information (e.g., timing information, time division duplex (“TDD”) uplink (“UL”)/downlink (“DL”) configuration, on/off signaling, spatial beamforming/transmission configuration indicator (“TCI”)-state/spatial transmission (“Tx”)/receiving (“Rx”) relation information, or the like) from the network, forwards signals received from a network node (in DL communication) to one or more devices (e.g., UEs, another repeater, in its communication range, or forwards signals received from one or more devices e.g., UEs (in UL communication), or both in radio frequency, without the need of baseband processing of the device's user plane data (e.g., physical downlink shared channel (“PDSCH”)/physical uplink shared channel (“PUSCH”)) channels/signals transmitted via either uplink or downlink. Note that a repeater can be deemed a “smart repeater,” if the repeater can pursue one of the following processes: adaptive beamforming, decode control and/or reference signal configuration information from a network node, or transmit control/reference signals to UE nodes.

In this disclosure, the following aspects of the problem are addressed:
Describing the communication framework between the network and the repeater node, including channel state information (“CSI”) reporting setting, transmit precoding matrix index (“TPMI”), synchronization signal (“SS”)/physical broadcast channel (“PBCH”) block transmission, timing advance measurement and reporting, and TCI state indication;
Introducing Repeater-assisted SS/PBCH block transmission to the UEs;
Resolving issues related to timing advance measurement and reporting with respect to the repeater node, as well as UL beam indication for the link between UEs and repeaters;
Proposing a modified interference management framework to account for synchronization issues in repeater nodes that may hinder efficient interference measurement and reporting processes on other UEs (e.g., UEs served with other TRPs/cells).

In the following descriptions, the terms antenna, panel, antenna panel, device panel and UE panel are used interchangeably. An antenna panel may be a hardware that is used for transmitting and/or receiving radio signals at frequencies lower than 6 GHz, e.g., frequency range 1 (“FR1”, i.e., frequencies from 410 MHz to 7125 MHz), or higher than 6 GHz, e.g., frequency range 2 (“FR2”, i.e., frequencies from 24.25 GHz to 52.6 GHz) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, the terms antenna, panel, and antenna panel are used interchangeably. An antenna panel may be a hardware that is used for transmitting and/or receiving radio signals at frequencies lower than 6 GHz, e.g., FR1, or higher than 6 GHz, e.g., FR2 or mmWave. In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (“QCL”) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, QCL-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (“AoA”) Dominant AoA, average AoA, angular spread, Power Angular Spectrum (“PAS”) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target reference signal (“RS”) of demodulation (“DM”)-RS ports of the target transmission during a transmission occasion) and a source reference signal(s) (e.g., SSB/CSI-RS/sounding reference signal (“SRS”)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a UL TCI state is provided if the UE is configured with separate DL/UL TCI by radio resource control (“RRC”) signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the embodiments described, a joint DL/UL TCI state is provided if the UE is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for UE-dedicated physical downlink control channel (“PDCCH”)/physical downlink shared channel (“PDSCH”)) and is used to determine UL spatial transmission filter (e.g., for UE-dedicated physical uplink shared channel (“PUSCH”)/physical uplink control channel (“PUCCH”)) for a control channel (“CC”) or across a set of configured CCs/bandwidth parts

(“BWPs”). In one example, the UL spatial transmission filter is derived from the RS of DL QCL Type D in the joint TCI state. The spatial setting of the UL transmission may be according to the spatial relation with a reference to the source RS configured with QCL-Type set to ‘typeD’ in the joint TCI state.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

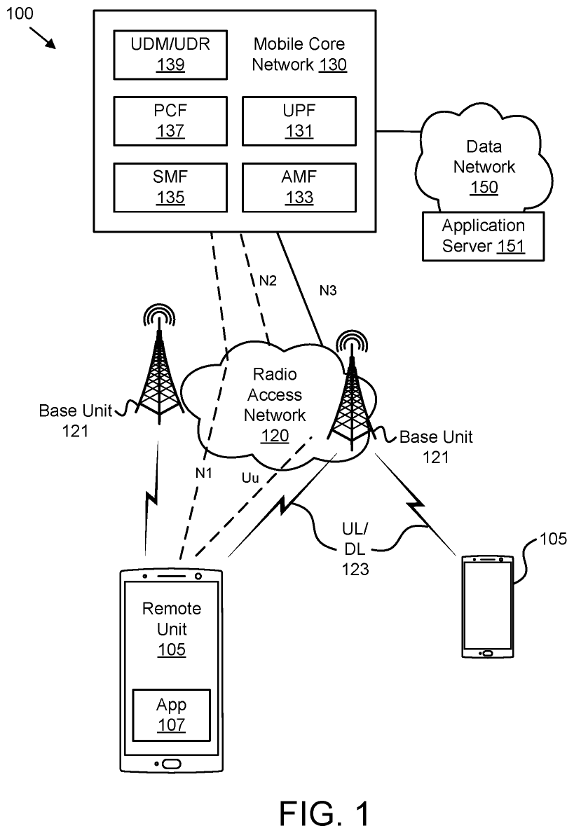

FIG. 1 depicts a wireless communication system 100 supporting repeater-assisted communication, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “‘attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QOS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

Below we list a set of preliminary assumptions for the problem:
Hereinafter, use of the “TRP” notion is used in a general fashion to include e.g., at least one of TRPs, cells, nodes, Panels, communication (e.g., signals/channels) associated with a control resource set (“CORESET”) pool, communication associated with a TCI state from a transmission configuration comprising at least two TCI states.
The codebook type used is arbitrary; flexibility is provided for use with different codebook types (Type-I and Type-II codebooks), unless otherwise stated.
We hereafter use the “repeater” notion in a general fashion to include e.g., at least one of a smart repeater, a relay, an IAB node, an intermediate node, or a reflecting surface.
A UE is triggered or scheduled with two or more downlink control information (“DCI”), wherein the multi-TRP scheme may be based on one of space division multiplexing (“SDM”) (scheme 1a), frequency division multiplexing (“FDM”) (schemes 2a/2b), and time division multiplexing (“TDM”) (schemes 3/4), as specified in (3GPP TS 38.214, March 2020, which is incorporated herein by reference). Other transmission schemes are not precluded.

Several embodiments are described below. According to a possible embodiment, one or more elements or features from one or more of the described embodiments may be combined.

In a first embodiment directed to an indication of repeater-assisted communication, a repeater-assisted communication (“RAC”) is indicated via configuring the UE with two CORESET Pool indices, wherein a CORESET, ControlResourceSet, may have a CORESET Pool Index, CORESETPoolIndex, indicating one of two CORESET Pool indices values, and two PDCCHs for the UE (e.g., with cyclic redundancy check (“CRC”) scrambled with UE-specific RNTI) in search spaces in the two CORESETs with different CORESET pool index value schedule a same PDSCH, e.g., same or repetition of PDSCH scheduling assignment in each of the PDCCH. The two PDCCH or the two search spaces in the two CORESETS with different CORESET pool index value may be linked e.g., in the case of PDCCH repetition.

In a second embodiment, RAC is indicated via configuring the UE with a TCI codepoint corresponding to two TCI states, wherein a first TCI state corresponds to a TRP network node and a second TCI state corresponds to the repeater. In one example, a reference signal transmitted from TRP cannot be quasi-co-located (QCLed) with that transmitted from a repeater according to QCL Type-D, wherein QCL Type-D depicts spatial relation QCL information

In a third embodiment, RAC is indicated via configuring the UE with a repetition scheme configuration, RepetitionSchemeConfig, under either PDSCH transmission configuration, PDSCH-Config, PDCCH transmission configuration, PDCCH-Config, PUSCH transmission configuration, PUSCH-Config or PUCCH transmission configuration, PUCCH-Config. In a first example, a new scheme, e.g., ‘SDM-Scheme’ is introduced as a new repetition scheme for RAC.

In a fourth embodiment, RAC is indicated via configuring the UE within a control information channel or signal, e.g., PDCCH DCI with a special format, wherein the control information channel indicates a set of one or more slots, a set of one or more physical resource blocks (“PRBs”), a set of one or more BWPs, or a combination thereof. In a first example, a new DCI format class, e.g., DCI format 4_x, that is dedicated for one or a combination of PDSCH, PDCCH, PUSCH, or PUCCH repetition with RAC. In a second example, an additional DCI format for other purposes, e.g., DCI format 2_7, is provided, e.g., which can indicate side control information (e.g., at least one of timing information, TDD UL/DL configuration, on/off signaling, spatial beamforming/TCI-state/spatial Tx/Rx relation information, etc.) for one or more repeaters e.g., different position in DCI fields can be configured for the different repeaters indicating the (starting) position (bit) of the side control information for the indicated repeater within the DCI payload.

In one embodiment directed to indication of UEs whose PDSCH/PUSCH transmissions are repeated, the control information signal corresponding to RAC includes a combination of one or more of the following: carrier indicator, BWP indicator, frequency domain resource assignment, or a time domain resource assignment, a set of one or more beam indicators, e.g., reference signal resource indictors.

In a second embodiment, configuration information of reference signals transmitted from the network to the repeater are indicated via one or a combination of a control information channel/message/signal, e.g., DCI, medium access control-control element (“MAC-CE”), or higher-layer signaling, wherein the indication describes the reference signal configuration. In a first example, the repeater receives a CSI-RS resource configuration as part of the side control information transmission, wherein the repeater transmits signal(s) corresponding to the configured CSI-RS resources. In one implementation, the side control information may be sent on a channel/link dedicated to the control signaling exchange between the TRP and repeater. In another implementation the side control information may be sent as part of Uu interface (e.g., PDCCH transmission), wherein dedicated/pre-defined DCI format mapped on pre-defined control channel elements (“CCEs”) and AL of the PDCCH to reduce/avoid the blind decoding candidate search at the repeater.

In a third embodiment, a subset of the UEs channels/signals transmitted in uplink transmission are repeated, wherein the repeated subset of the UEs is selected based on a threshold with respect to one or more of L1-signal to interference noise ratio (“SINR”), L1-reference signal received power (“RSRP”), or channel quality indicator (“CQI”) value. In a first example, a PUSCH from a first UE is forwarded via the repeater if a DL L1-SINR reported in a CSI report (e.g., via a prior PUCCH transmission) is lower than a pre-defined threshold value.

In a fourth embodiment, the TRP configures the repeater to forward UL signals received from a UE based on its corresponding SRS received power. In one example, if the TRP received power of the previous SRS(s) transmission, transmitted from the UE to the TRP, is below a certain threshold, the TRP triggers or activates the repeater to forward the next or subsequent UL (e.g., PUCCH/PUSCH/SRS) transmission.

In a fifth embodiment, if CRC failing/hybrid automatic repeat request (“HARQ”)-negative acknowledgement (“NACK”) counter for a certain PUSCH transport block (“TB”) from a UE reached a predefined threshold value, the TRP triggers/configures/activates the repeater to forward the remaining retransmissions of that PUSCH TB or the subsequent UL transmission from the UE.

In a sixth embodiment, the control information signal is not associated with a DMRS signal, e.g., DMRS-less, and instead is selected from a sequence set corresponding to a pre-defined number of bits, and wherein all possible sequences that can be selected are one of orthogonal, quasi-orthogonal, or pseudo-orthogonal.

In one embodiment directed to communication between the TRP and the repeater, in general, repeater behavior during SSB reception, CSI-RS reception, SRS transmission to identify beams, CSI and UL TPMI, respectively, is expected to follow a similar behavior to that of a UE (e.g., Uu interface), e.g., the network communicates with the repeater to establish a timing advance, CSI, TPMI, UL/DL beams. Several embodiments are described below. According to a possible embodiment, one or more elements or features from one or more of the described embodiments may be combined.

In a first embodiment, a repeater is configured by the network with a CSI reporting setting, a CSI-RS resource setting, an SRS configuration, or a combination thereof.

In a second embodiment, a repeater cannot be configured with either PDSCH reception, PUSCH transmission, DMRS for PDSCH reception, DMRS for PDCCH reception (if the side control information is not part of PDCCH), DMRS for PUSCH transmission, or a combination thereof. In a first example, the repeater cannot be configured with PDSCH reception, or PUSCH transmission.

In a third embodiment, a timing advance MAC CE (e.g., PDCCH MAC CE) is transmitted from the network to the repeater to adjust and maintain the transmission timing from the repeater.

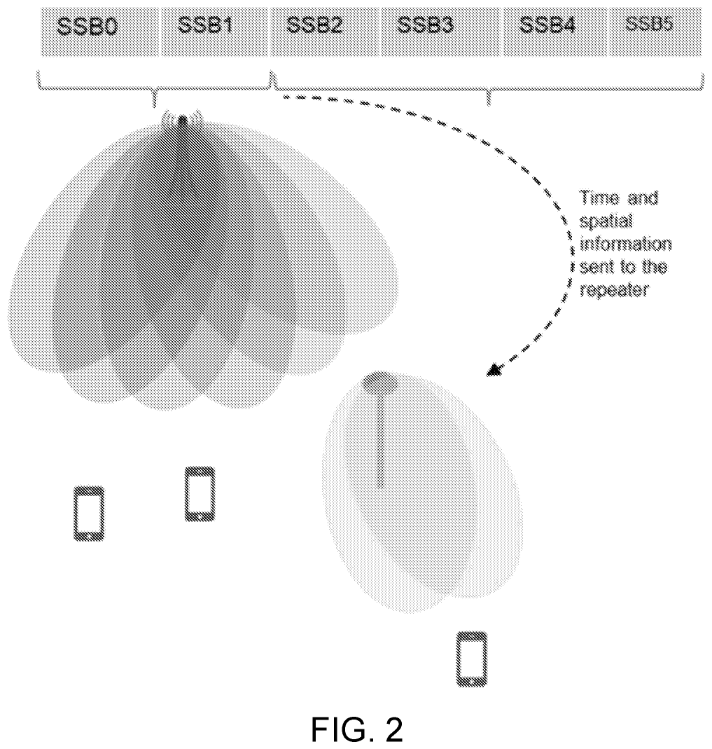

In a fourth embodiment, two SSB RS groups are configured, wherein a first SSB RS group is transmitted to a repeater node, and wherein a second SSB RS group is transmitted to one or more UE nodes as depicted in FIG. 2. The TRP may indicate to the repeater the time and spatial beam information (e.g., TCI state).

In a fifth embodiment, the control information sequence or message transmitted from the network to configure the repeater is indicated/provided/signaled via Uu link.

In a sixth embodiment, the control information sequence or message transmitted from the network to configure the repeater is indicated/provided/signaled via non-NR (e.g., non-3GPP RAT) link.

In a seventh embodiment, the control information sequence or message comprises a CSI reporting configuration within a CSI-RS resource configuration corresponding to an non-zero power (“NZP”) CSI-RS resource for interference measurement, or a CSI-IM resource for interference measurement, or a combination thereof.

In an eighth embodiment, the control information sequence or message comprises a bitmap, wherein the bitmap comprises a sequence of bits that indicate the active resources, e.g., resources at which the repeater would transmit, receive, or both. In a first example, the bitmap is one-dimensional, wherein the one dimension corresponds to time, frequency resources, or a combination thereof. In a second example, the bitmap is two-dimensional, wherein the two dimensions correspond to time and frequency resources.

In one embodiment directed to SSB transmission in the presence of a repeater, under the aforementioned setup, three classes of UEs exist:
Class A: UEs with strong link to TRP but weak/no link to repeater. Class A UEs are expected to communicate directly with a TRP (e.g., for PDSCH/PDCCH/PUSCH/PUCCH channels and signals (like CSI-RS and SRS) reception/transmission).
Class B: UEs with strong link to repeater but weak/no link to TRP. Class B UEs are expected to communicate through a repeater with a TRP (e.g., for PDSCH/PDCCH/PUSCH/PUCCH channels and signals (like CSI-RS and SRS) reception/transmission).
Class C: UEs with strong link to both TRP and repeater. Note that Class C UEs can resemble either Class A UEs or Class B UEs in behavior. Here, without loss of generality, we assume a Class C UE would communicate directly with a TRP (e.g., for PDSCH/PDCCH/PUSCH/PUCCH channels and signals (like CSI-RS and SRS) reception/transmission).

Note that if an SSB is only transmitted from TRP (repeater is not transmitting SSB signals), Class B UEs may not be assigned appropriate beams, and connectivity is not resolved for this class.

On the other hand, if SSB is transmitted from repeater only (SSB communicated to repeater via a private (e.g., non-3GPP NR RAT) link), Class A UEs will not be assigned appropriate beams, and connectivity is not resolved for this class.

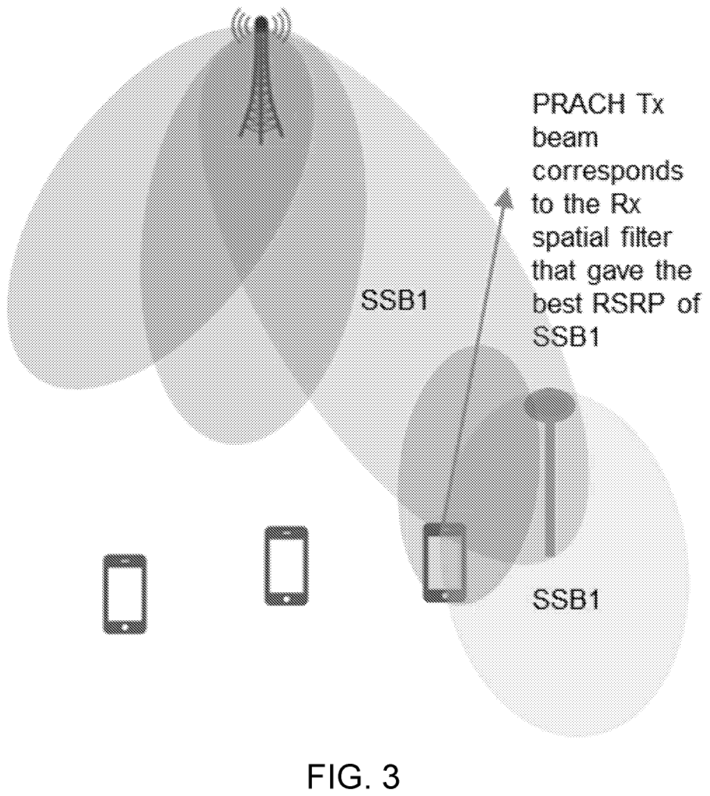

As shown in FIG. 3, if SSB is transmitted from TRP and repeated or forwarded by the repeater, Class C UEs will report a compound beam that corresponds to the mean value of the two beams from TRP and repeater. This compound beam does not correspond to either the TRP or repeater beam. Once the UE identifies this combined SSB (received from both TRP and repeater) as the best detected SSB, it uses a Tx spatial filter corresponds to the Rx spatial filter that gives the best SSB RSRP or the SSB with RSRP above a threshold, for its PRACH transmission.

Several embodiments are described below. According to a possible embodiment, one or more elements or features from one or more of the described embodiments may be combined.

In a first embodiment, beams in SS/PBCH block resources are decomposed into two subsets of beam groups, wherein a first subset of beams is transmitted from a TRP, and a second subset of beams is transmitted from a repeater. In a first example, a one SS/PBCH block is associated with two TCI states (or transmitted with two beams), wherein a first TCI state corresponds to a beam from the first subset of beams, and a second TCI state corresponds to a beam from the second subset of beams. In a second example, beams that are received before a given time threshold correspond to the first subset of beam groups, whereas beams that are received after a given time threshold correspond to the second subset of beam groups. In a third example, beams that are received before a given frequency threshold correspond to the first subset of beam groups, whereas beams that are received after a given frequency threshold correspond to the second subset of beam groups. In some examples, all SSBs are transmitted from the TRP, however a subset of the SSBs is repeated/forwarded by the repeater.

In a second embodiment, two SS/PBCH block transmission occasions occur, wherein a first SS/PBCH block transmission is transmitted from the TRP, and wherein a second SS/PBCH block transmission is transmitted from the repeater. In a first example, the two SS/PBCH blocks are associated with two TCI states, wherein a first TCI state corresponds to the first SS/PBCH block, and a second TCI state corresponds to the second SS/PBCH block.

In a third embodiment, a UE tracks and/or reports a subset of two beams from a set of beams in the SS/PBCH block. In a first example, the UE receives an indication of tracking two beams from the SS block, given that the UE is capable of tracking and/or reporting two beams based on a UE capability feature. In a second example, the UE reports an SSBRI codepoint that corresponds to two SSB resources.

In a fourth embodiment, a UE selects the SSB, PRACH and the related ROs based on the highest RSRP, reference signal received quality (“RSRQ”), SINR, or a combination thereof, of the detected SSBs or based on the SSB RSRP, RSRQ, SINR, or a combination thereof, above a certain threshold for the detected SSBs.

In a fifth embodiment, the network transmits configuration information to the repeater, e.g., a special DCI format directed to the repeater, that comprises information corresponding to the SS/PBCH block. In a first example, if beams in SS/PBCH block resources are decomposed into two subsets of beam groups, configuration information corresponding to only one subset of the beam group is indicated/provided/signaled to the repeater.

In embodiments directed to interference from repeater on other UEs, one disadvantage of introducing a repeater to a network is the interference that can be caused by the repeater transmission on UEs in the same cell, as well as UEs in one or more neighboring cells. Note that one distinct feature of the repeater is the lack of synchronization between the repeater and other nodes in the network, e.g., in-cell and out-of-cell TRPs.

For instance, assume a setup with Class C UEs, wherein the power of the channel between a one Class C UE and the repeater is comparable to the power of the channel between the UE and the serving TRP. In such case, precise measurement of the interference incurred from the repeater transmission is needed so that the UE can apply interference cancellation and/or rejection to improve the relative ratio between the desired signal power and the interference-plus-noise power. However, as described above, due to the relatively cheaper cost of the RF circuitry in a repeater, errors in time, frequency synchronization, or both, can make interference measurement even more challenging.

Several embodiments are described below. According to a possible embodiment, one or more elements or features from one or more of the described embodiments may be combined.

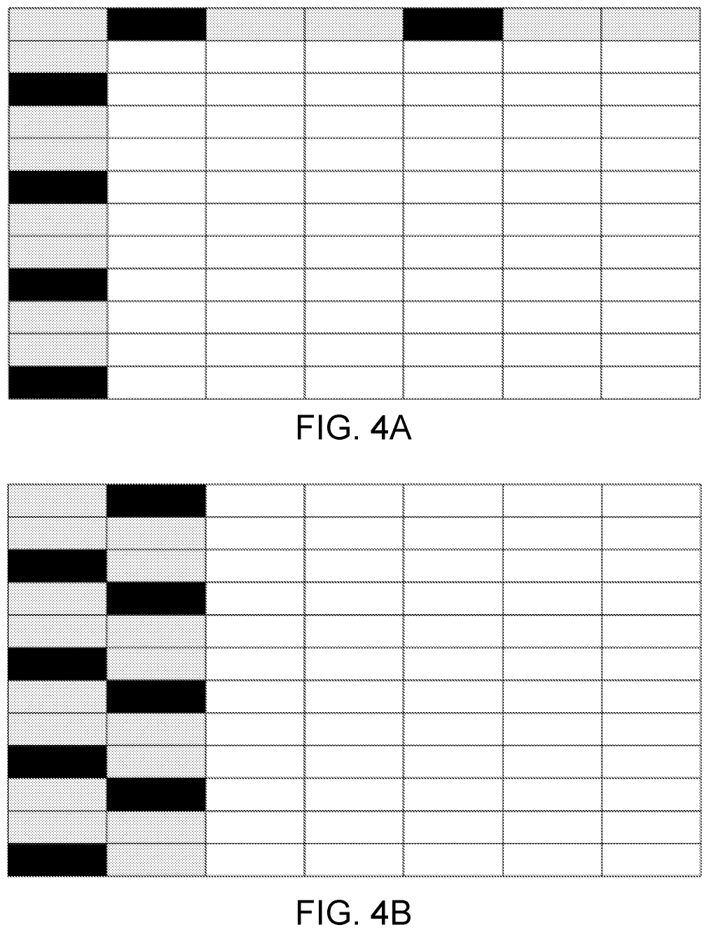

In a first embodiment, a network node configures a UE with a CSI-RS resource configuration corresponding to an NZP CSI-RS resource for interference measurement, or a CSI-interference measurement (“IM”) resource for interference measurement, or a combination thereof, wherein the CSI-RS configuration includes two or more adjacent OFDM symbols in time within a same sub-carrier being pre-empted to enable interference measurement, two or more adjacent sub-carriers within a same OFDM symbol time being pre-empted to enable interference measurement, or a combination thereof, as shown in Example 1 (FIG. 4A) and Example 2 (FIG. 4B).

In a second embodiment, a network node configures a UE with a CSI-RS resource configuration corresponding to an NZP CSI-RS resource for interference measurement, wherein the CSI-RS configuration includes two or more adjacent OFDM symbols in time within a same sub-carrier being transmitted from the repeater to enable interference measurement, two or more adjacent sub-carriers within a same OFDM symbol time being transmitted from the repeater to enable interference measurement, or a combination thereof, as shown in Example 4 (FIG. 4D).

Note that the figure in Example 3 (FIG. 4C) emphasizes the problem with not pre-empting consecutive symbols or sub-carriers or both for interference measurement, as well as the problem with not transmitting CSI-RS symbols over consecutive symbols or sub-carriers or both for interference measurement.

In a third embodiment, RAC is associated with NR frame structures with extended CP, e.g., RAC is only supported for SCS of 60 kHz with extended CP, or extended CP is also supported for NR frame structures with SCS that is below 60 kHz.

In a fourth embodiment, for CSI reporting configuration under RAC, the CSI reporting configuration may configure the UE with reporting interference covariance information corresponding to interference from a repeater, wherein the interference from the repeater is measured via at least one NZP CSI-RS resource transmitted from the repeater, and wherein the at least one NZP CSI-RS resource comprises one or more ports. In a first example, the interference covariance is reported in terms of a set of differential coefficients, wherein the differential coefficients are reported in the form of a set of amplitude values corresponding to a codebook of non-negative values up to one, and a set of phase values corresponding to a uniform set of phase values. In a second example, the interference covariance is reported in the form of a set of one or more beam indices, e.g., the beam indices correspond to column indices of a standard DFT matrix with one or more phase rotation factors.

In a fifth embodiment, the network configures the repeater with a codebook subset restriction (“CBSR”), which corresponds to the spatial beams that are restricted for the repeater. In a first example, the CBSR configuration is reported as part of a CSI reporting configuration intended to the repeater. In a second example, the CBSR configuration is reported as part of a control information sequence, e.g., DCI, that is transmitted from the network to the repeater. In a third example, the CBSR configuration follows that of the CBSR configuration for Type-I codebook in Clause 5.2.2.2.1 of R1-1907424, Ericsson, “Views on CSI framework for multi-TRP,” Reno, USA, May. 13-17, 2019, which is incorporated herein by reference. In a fourth example, the CBSR configuration follows that of the CBSR configuration for Type-II codebook in Clause 5.2.2.2.3 of R1-1907424, Ericsson, “Views on CSI framework for multi-TRP,” Reno, USA, May. 13-17, 2019, which is incorporated herein by reference.

In a fourth sixth embodiment, for CSI reporting configuration under RAC, the UE is configured with a multi-TRP CSI reporting setting for two TRPs, wherein the CSI reporting setting is configured with two CMR groups, and wherein a first of the two CMR groups is associated with a

TRP, and a second of the two CMR groups is associated with a repeater.
Example 1 (FIG. 4A): gray fields are pre-empted resource elements (“REs”), black fields correspond to RSs transmitted from the repeater. Lack of synchronization on either time or frequency can be handled. Drawback: large loss in resources.
Example 2 (FIG. 4B): gray fields are pre-empted REs, black fields correspond to RSs transmitted from the repeater.
Example 3 (FIG. 4C): gray fields are pre-empted REs, black fields correspond to RSs transmitted from the repeater. Repeater transmits non-consecutive symbols in time/frequency, signal is averaged over the RE. Drawback: partial interference on neighboring cells+channel estimate is not precise due to averaging errors.
Example 4 (FIG. 4D): gray fields are pre-empted REs, black fields correspond to RSs transmitted from the repeater. Repeater transmits consecutive symbols in time/frequency to overcome time/frequency sync issues. Drawback: interference on neighboring cells.

In embodiments directed to uplink control information from the repeater to the network, for class B UEs whose channel with a repeater are relatively stronger compared with the channel with a TRP, one issue that may occur is computing and reporting the appropriate timing advance to the UE based on its communication with the repeater. Note that a similar issue may occur for UL beam selection, since the UL beam needs to be measured at the repeater for relevant beam selection. Several embodiments are described below. According to a possible embodiment, one or more elements or features from one or more of the described embodiments may be combined.

In a first embodiment, a repeater feeds back an uplink control information (“UCI”) sequence of bits to the network, wherein the UCI sequence of bits includes information related to one or more of a set of timing advance indicators, and a set of UL beam indices corresponding to reference signal resource indicators. In a first example, a timing advance indicator is reported for each UE communicating its PUSCH transmission to the repeater. In a second example, an UL beam indicator is reported for each UE communicating its PUSCH transmission to the repeater.

In a second embodiment, the repeater receives information related to a set of one or more SRS configurations intended for one or more UEs. In a first example, the set of SRS configurations is shared with the repeater via a PDCCH DCI corresponding to a DCI format related to RAC. In a second example, the set of SRS configurations is shared with the repeater via MAC CE communication. In a third embodiment, the set of SRS configurations is shared with the repeater via higher-layer configuration.

In a third embodiment, the repeater transmits a timing advance indicator to each UE. In another embodiment, the TRP determines and adjust the transmission timing (or TA) of a UE communicating through a repeater based on the transmission timing or TA of the repeater UL transmissions to the TRP. The TA of the UE may further be based on the signals/channels received by the TRP from the UE (e.g., directly and/or through the repeater). The TRP indicates the transmission timing adjustment via a timing advance indicator to the UE.

In a fourth embodiment, a UE communicating to the network via RAC is configured with an SRS configuration, wherein the SRS configuration includes a spatial relation information that indicates an NZP CSI-RS resource, which can be used to infer the UL beam which the UE should select for PUSCH transmission, and/or PUCCH transmission.

Also, one other issue is the interference at the repeater during UL transmission, since this interference would be amplified and forwarded to the network by the repeater. Note that even if the repeater can measure and estimate the interference, it may not be able to cancel the interference, since it may not be able to pursue baseband processing on the signal. Therefore, the repeater may forward an estimate of the UL interference to the network, which in turn can cancel the interference.

In a fifth embodiment, the repeater transmits a special uplink control sequence, e.g., UCI, wherein the uplink control sequence comprises interference covariance information. In a first example, the interference covariance is reported in terms of a set of differential coefficients, wherein the differential coefficients are reported in the form of a set of amplitude values corresponding to a codebook of non-negative values up to one, and a set of phase values corresponding to a uniform set of phase values. In a second example, the interference covariance is reported in the form of a set of one or more beam indices, e.g., the beam indices correspond to column indices of a standard discrete Fourier transform (“DFT”) matrix with one or more phase rotation factors.

In a sixth embodiment, the special uplink control sequence is not associated with a DMRS signal, and instead is selected from a sequence comprising a pre-defined number of bits, and wherein all possible sequences that can be selected are one of orthogonal, quasi-orthogonal, or pseudo-orthogonal.

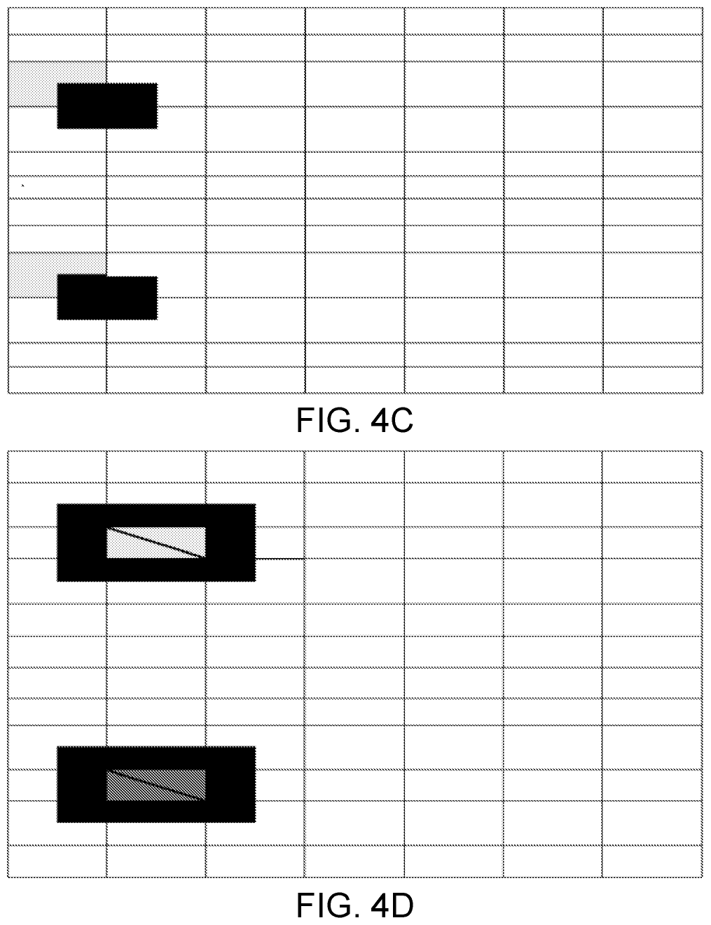

FIG. 5 depicts a NR protocol stack 500, according to embodiments of the disclosure. While FIG. 5 shows the remote unit 105, the base unit 121 and the mobile core network 130, these are representative of a set of UEs interacting with a RAN node and a NF (e.g., AMF) in a core network. As depicted, the protocol stack 500 comprises a User Plane protocol stack 505 and a Control Plane protocol stack 510. The User Plane protocol stack 505 includes a physical (“PHY”) layer 515, a Medium Access Control (“MAC”) sublayer 520, a Radio Link Control (“RLC”) sublayer 525, a Packet Data Convergence Protocol (“PDCP”) sublayer 530, and Service Data Adaptation Protocol (“SDAP”) layer 535. The Control Plane protocol stack 510 also includes a physical layer 515, a MAC sublayer 520, a RLC sublayer 525, and a PDCP sublayer 530. The Control Place protocol stack 510 also includes a Radio Resource Control (“RRC”) layer and a Non-Access Stratum (“NAS”) layer 545.

The AS protocol stack for the Control Plane protocol stack 510 consists of at least RRC, PDCP, RLC and MAC sublayers, and the physical layer. The AS protocol stack for the User Plane protocol stack 505 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 540 and the NAS layer 545 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 515 offers transport channels to the MAC sublayer 520. The MAC sublayer 520 offers logical channels to the RLC sublayer 525. The RLC sublayer 525 offers RLC channels to the PDCP sublayer 530. The PDCP sublayer 530 offers radio bearers to the SDAP sublayer 535 and/or RRC layer 540. The SDAP sublayer 535 offers QoS flows to the mobile core network 130 (e.g., 5GC). The RRC layer 540 provides for the addition, modification, and release of Carrier Aggregation and/or Dual Connectivity. The RRC layer 540 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

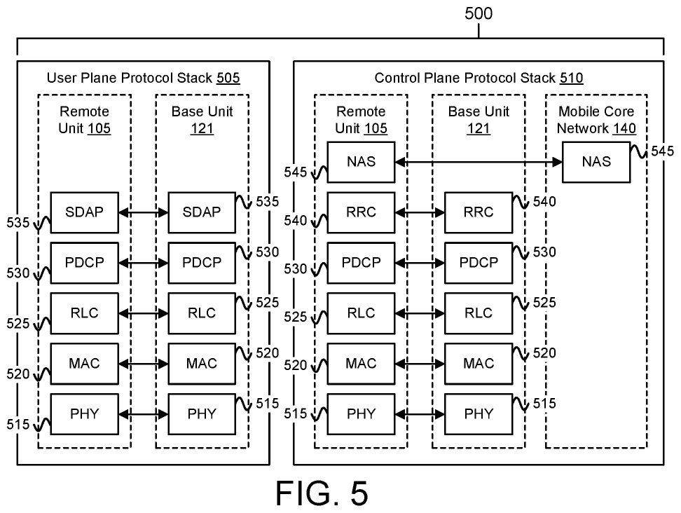

FIG. 6 depicts a user equipment apparatus 600 that may be used for repeater-assisted communication, according to embodiments of the disclosure. In various embodiments, the user equipment apparatus 600 is used to implement one or more of the solutions described above. The user equipment apparatus 600 may be one embodiment of a UE, such as the remote unit 105 and/or the UE 205, as described above. Furthermore, the user equipment apparatus 600 may include a processor 605, a memory 610, an input device 615, an output device 620, and a transceiver 625. In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more base units 121. Additionally, the transceiver 625 may support at least one network interface 640 and/or application interface 645. The application interface(s) 645 may support one or more APIs. The network interface(s) 640 may support 3GPP reference points, such as Uu and PC5. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 605 may include an application processor (also known as “main processor”) which manages application-domain and operating system (“OS”) functions and a baseband processor (also known as “baseband radio processor”) which manages radio functions.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to repeater-assisted communication. For example, the memory 610 may store parameters, configurations, resource assignments, policies, and the like as described above. In certain embodiments, the memory 610 also stores program code and related data, such as an operating system or other controller algorithms operating on the user equipment apparatus 600, and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. The transceiver 625 may be used to provide UL communication signals to a base unit 121 and to receive DL communication signals from the base unit 121, as described herein. Similarly, the transceiver 625 may be used to transmit and receive SL signals (e.g., V2X communication), as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an ASIC, or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

In one embodiment, the processor 605 is configured to receive, from a network, an indication of RAC for the apparatus 600, receive, from the network, configuration information comprising at least one of frequency resources and time resources that the apparatus 600 uses for RAC, receive, from the network, configuration information for reference signals that are transmitted from the network to the apparatus 600, and determine an indication of one or more UE devices whose transmissions are repeated by the apparatus 600.

In one embodiment, the indication of RAC is based on configuring a UE with two CORESET pool indices, configuring the UE with two TCI states, configuring the UE with a DCI with a special format that indicates communication between a network node and the apparatus 600, or some combination thereof.

In one embodiment, the RAC indication based on the two CORESET pool indices also comprises two PDCCHs for the UE in search spaces in the two CORESETs with different CORESET pool index value schedules for a same PDSCH.

In one embodiment, the two PDCCH s or the two search spaces in the two CORESETs with different CORESET pool index values are linked.

In one embodiment, the RAC indication based on two TCI states comprises a first TCI state corresponding to a transmit/receive point network node and a second TCI state corresponding to the apparatus 600.

In one embodiment, the RAC indication based on the DCI comprises a set of one or more slots, a set of one or more PRBs, a set of one or more BWPs, or a combination thereof.

In one embodiment, fields of the configuration information comprising frequency and time resources that the apparatus 600 uses for RAC comprises a DCI format comprising a carrier indicator, a BWP indicator, a frequency domain resource assignment, a time domain resource assignment, a set of one or more beam indicators, or some combination thereof.

In one embodiment, the processor 605 is configured to receive a CSI-RS resource configuration as part of a side control information transmission, the side control information sent on a channel dedicated to a control signaling exchange between a TRP and the apparatus 600.

In one embodiment, the processor 605 is configured to repeat a subset of UE beams in uplink transmission, the subset of UE beams selected based on a threshold with response to one or more of L1-SINR, L1-RSRP, or CQI value.

In one embodiment, a TRP configures the apparatus 600 to forward uplink signals received from a UE based on its corresponding SRS received power.

In one embodiment, the TRP configures the apparatus 600 to forward remaining retransmissions of a PUSCH TB or subsequent uplink transmissions from the UE in response to CRC failing for the PUSCH TB.

In one embodiment, a control information signal is selected from a sequence set corresponding to a pre-defined number of bits, wherein possible sequences that are selected are orthogonal, quasi-orthogonal, pseudo-orthogonal, or some combination of the foregoing.

In one embodiment, the configuration information of reference signals transmitted from the network to the repeater is indicated via one or a combination of DCI, MAC-CE, or higher-layer signaling.

In one embodiment, the apparatus 600 is configured by the network with a CSI reporting setting, a CSI-RS resource setting, a SRS configuration, a timing advance value, or some combination thereof.

In one embodiment, a first SSB RS group is transmitted to the apparatus 600, and wherein a second SSB RS group is transmitted to one or more UEs.

In one embodiment, the processor 605 is configured to receive control information from the network.

In one embodiment, the control information comprises a bitmap, the bitmap comprising a sequence of bits that indicate active resources for the apparatus to transmit, receive, or some combination of both.

In one embodiment, beams in SS/PBCH block resources are decomposed into two subsets of beam groups, wherein a first subset of beams is transmitted from the network and a second subset of beams is transmitted from the apparatus 600.

In one embodiment, two SS/PBCH block transmission occasions occur, wherein a first SS/PBCH block transmission is transmitted from the network node, and wherein a second SS/PBCH block transmission is transmitted from the apparatus 600.

In one embodiment, a UE reports indices of a subset of two beams from a set of beams in a SS/PBCH block.

In one embodiment, the RAC is associated with NR frame structures with extended cyclic prefix.

In one embodiment, the apparatus 600 is configured with a multi-TRP CSI reporting setting for two TRPs, wherein the CSI reporting setting is configured with two CMR groups, and

wherein a first of the two CMR groups is associated with a network node, and a second of the two CMR groups is associated with a repeater node.

In one embodiment, the processor is configured to feed back a UCI sequence of bits to the network, wherein the UCI sequence of bits comprises information related to one or more of a set of timing advance indicators and a set of UL beam indices corresponding to reference signal resource indicators.

In one embodiment, the processor 605 is configured to receive information related to a set of one or more SRS configurations intended for a set of UE nodes.

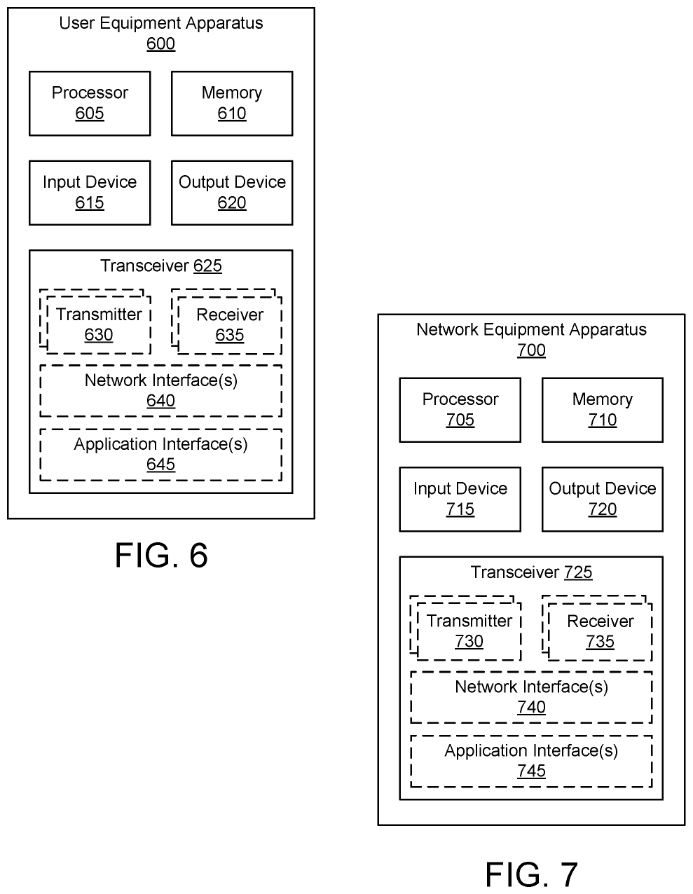

FIG. 7 depicts one embodiment of a network apparatus 700 that may be used for repeater-assisted communication in 5G NR, according to embodiments of the disclosure. In some embodiments, the network apparatus 700 may be one embodiment of a RAN node and its supporting hardware, such as the base unit 121 and/or gNB, described above. Furthermore, network apparatus 700 may include a processor 705, a memory 710, an input device 715, an output device 720, and a transceiver 725. In certain embodiments, the network apparatus 700 does not include any input device 715 and/or output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2, N3, N5, N6 and/or N7 interfaces. Other network interfaces 740 may be supported, as understood by one of ordinary skill in the art.

When implementing an NEF, the network interface(s) 740 may include an interface for communicating with an application function (i.e., N5) and with at least one network function (e.g., UDR, SFC function, UPF) in a mobile communication network, such as the mobile core network 130.

The processor 705, in one embodiment, may include any known controller capable of executing computer-readable instructions and/or capable of performing logical operations. For example, the processor 705 may be a microcontroller, a microprocessor, a CPU, GPU, an auxiliary processing unit, an FPGA, a DSP, a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and OS functions and a baseband processor (also known as “baseband radio processor”) which manages radio function. In various embodiments, the processor 705 controls the network apparatus 700 to implement the above described network entity behaviors (e.g., of the gNB) for repeater-assisted communication in 5G NR.

The memory 710, in one embodiment, is a computer readable storage medium. In some embodiments, the memory 710 includes volatile computer storage media. For example, the memory 710 may include a RAM, including DRAM, SDRAM, and/or SRAM. In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data relating to repeater-assisted communication. For example, the memory 710 may store parameters, configurations, resource assignments, policies, and the like as described above. In certain embodiments, the memory 710 also stores program code and related data, such as an OS or other controller algorithms operating on the network apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, may include any known electronically controllable display or display device. The output device 720 may be designed to output visual, audible, and/or haptic signals. In some embodiments, the output device 720 includes an electronic display capable of outputting visual data to a user. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, all or portions of the output device 720 may be located near the input device 715.

As discussed above, the transceiver 725 may communicate with one or more remote units and/or with one or more interworking functions that provide access to one or more PLMNs. The transceiver 725 may also communicate with one or more network functions (e.g., in the mobile core network 80). The transceiver 725 operates under the control of the processor 705 to transmit messages, data, and other signals and also to receive messages, data, and other signals. For example, the processor 705 may selectively activate the transceiver (or portions thereof) at particular times in order to send and receive messages.

The transceiver 725 may include one or more transmitters 730 and one or more receivers 735. In certain embodiments, the one or more transmitters 730 and/or the one or more receivers 735 may share transceiver hardware and/or circuitry. For example, the one or more transmitters 730 and/or the one or more receivers 735 may share antenna(s), antenna tuner(s), amplifier(s), filter(s), oscillator(s), mixer(s), modulator/demodulator(s), power supply, and the like. In one embodiment, the transceiver 725 implements multiple logical transceivers using different communication protocols or protocol stacks, while using common physical hardware.

In one embodiment, the processor 705 transmits, to a repeater, an indication of RAC for the apparatus 700, transmit, to the repeater, configuration information comprising at least one of frequency resources and time resources that the apparatus 700 uses for RAC, transmit, to the repeater, configuration information for reference signals that are transmitted from the repeater to the network, and transmit, to the repeater, an indication of one or more UE devices whose transmissions are repeated by the repeater.

In one embodiment, the processor 705 configures a UE with a CSI-RS resource configuration corresponding to an NZP CSI-RS resource for interference measurement, or a CSI-IM resource for interference measurement, or a combination thereof, wherein the CSI-RS configuration includes two or more adjacent OFDM symbols in time within a same sub-carrier being pre-empted to enable interference measurement, two or more adjacent sub-carriers within a same OFDM symbol time being pre-empted to enable interference measurement, or some combination thereof.

In one embodiment, the processor 705 configures a UE with a CSI-RS resource configuration corresponding to an NZP CSI-RS resource for interference measurement, wherein the CSI-RS configuration includes two or more adjacent OFDM symbols in time within a same sub-carrier being transmitted from the repeater to enable interference measurement, two or more adjacent sub-carriers within a same OFDM symbol time being transmitted from the repeater to enable interference measurement, or some combination thereof.

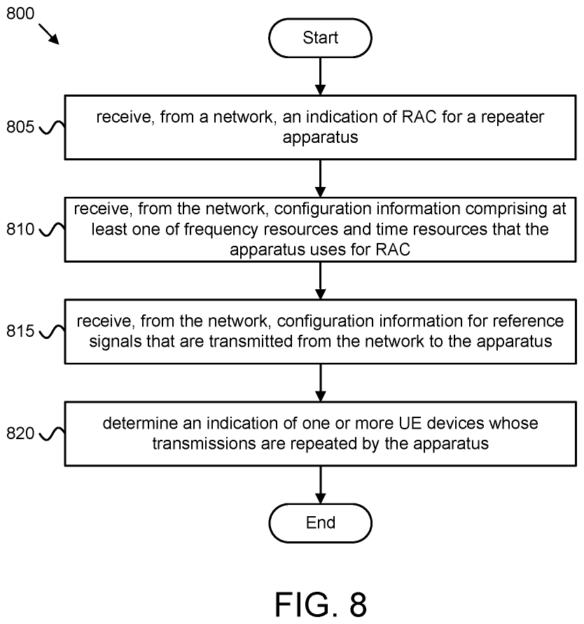

FIG. 8 is a flowchart diagram of a method 800 for repeater-assisted communication. The method 800 may be performed by a UE as described herein, for example, the remote unit 105 and/or the user equipment apparatus 600. In some embodiments, the method 800 may be performed by a processor executing program code, for example, a microcontroller, a microprocessor, a CPU, a GPU, an auxiliary processing unit, a FPGA, or the like.

In one embodiment, the method 800 begins and receives 805, from a network, an indication of RAC for a repeater apparatus. In one embodiment, the method 800 receives 810, from the network, configuration information comprising at least one of frequency resources and time resources that the apparatus uses for RAC. In one embodiment, the method 800 receives 815, from the network, configuration information for reference signals that are transmitted from the network to the apparatus. In one embodiment, the method 800 determines 820 an indication of one or more UE devices whose transmissions are repeated by the apparatus, and the method 800 ends.

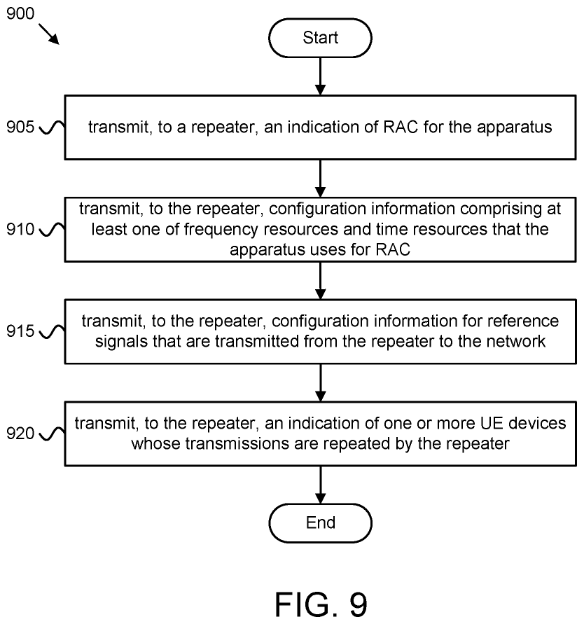

FIG. 9 is a flowchart diagram of a method 900 for repeater-assisted communication. The method 900 may be performed by a network entity as described herein, for example, the base unit 121, the gNB, and/or the network equipment apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and transmits 905, to a repeater, an indication of RAC for the apparatus. In one embodiment, the method 900 transmits 910, to the repeater, configuration information comprising at least one of frequency resources and time resources that the apparatus uses for RAC. In one embodiment, the method 900 transmits 915, to the repeater, configuration information for reference signals that are transmitted from the repeater to the network. In one embodiment, the method 900 transmits 920 an indication of one or more UE devices whose transmissions are repeated by the repeater, and the method 900 ends.

A first apparatus is disclosed for repeater-assisted communication. The first apparatus may include a UE as described herein, for example, the remote unit 105 and/or the user equipment apparatus 600. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor and a memory coupled to the processor. In one embodiment, the processor is configured to cause the apparatus to receive, from a network, an indication of RAC for the apparatus, receive, from the network, configuration information comprising at least one of frequency resources and time resources that the apparatus uses for RAC, receive, from the network, configuration information for reference signals that are transmitted from the network to the apparatus, and determine an indication of one or more UE devices whose transmissions are repeated by the apparatus.

In one embodiment, the indication of RAC is based on configuring a UE with two CORESET pool indices, configuring the UE with two TCI states, configuring the UE with a DCI with a special format that indicates communication between a network node and the apparatus, or some combination thereof.

In one embodiment, the RAC indication based on the two CORESET pool indices also comprises two PDCCHs for the UE in search spaces in the two CORESETs with different CORESET pool index value schedules for a same PDSCH.

In one embodiment, the two PDCCH s or the two search spaces in the two CORESETs with different CORESET pool index values are linked.

In one embodiment, the RAC indication based on two TCI states comprises a first TCI state corresponding to a transmit/receive point network node and a second TCI state corresponding to the apparatus.

In one embodiment, the RAC indication based on the DCI comprises a set of one or more slots, a set of one or more PRBs, a set of one or more BWPs, or a combination thereof.

In one embodiment, fields of the configuration information comprising frequency and time resources that the apparatus uses for RAC comprises a DCI format comprising a carrier indicator, a BWP indicator, a frequency domain resource assignment, a time domain resource assignment, a set of one or more beam indicators, or some combination thereof.

In one embodiment, the processor is configured to receive a CSI-RS resource configuration as part of a side control information transmission, the side control information sent on a channel dedicated to a control signaling exchange between a TRP and the apparatus.

In one embodiment, the processor is configured to repeat a subset of UE beams in uplink transmission, the subset of UE beams selected based on a threshold with response to one or more of L1-SINR, L1-RSRP, or CQI value.

In one embodiment, a TRP configures the apparatus to forward uplink signals received from a UE based on its corresponding SRS received power.

In one embodiment, the TRP configures the apparatus to forward remaining retransmissions of a PUSCH TB or subsequent uplink transmissions from the UE in response to CRC failing for the PUSCH TB.

In one embodiment, a control information signal is selected from a sequence set corresponding to a pre-defined number of bits, wherein possible sequences that are selected are orthogonal, quasi-orthogonal, pseudo-orthogonal, or some combination of the foregoing.

In one embodiment, the configuration information of reference signals transmitted from the network to the repeater is indicated via one or a combination of DCI, MAC-CE, or higher-layer signaling.

In one embodiment, the apparatus is configured by the network with a CSI reporting setting, a CSI-RS resource setting, a SRS configuration, a timing advance value, or some combination thereof.

In one embodiment, a first SSB RS group is transmitted to the apparatus, and wherein a second SSB RS group is transmitted to one or more UEs.

In one embodiment, the processor is configured to receive control information from the network.

In one embodiment, the control information comprises a bitmap, the bitmap comprising a sequence of bits that indicate active resources for the apparatus to transmit, receive, or some combination of both.

In one embodiment, beams in SS/PBCH block resources are decomposed into two subsets of beam groups, wherein a first subset of beams is transmitted from the network and a second subset of beams is transmitted from the apparatus.

In one embodiment, two SS/PBCH block transmission occasions occur, wherein a first SS/PBCH block transmission is transmitted from the network node, and wherein a second SS/PBCH block transmission is transmitted from the apparatus.

In one embodiment, a UE reports indices of a subset of two beams from a set of beams in a SS/PBCH block.

In one embodiment, the RAC is associated with NR frame structures with extended cyclic prefix.

In one embodiment, the apparatus is configured with a multi-TRP CSI reporting setting for two TRPs, wherein the CSI reporting setting is configured with two CMR groups, and wherein a first of the two CMR groups is associated with a network node, and a second of the two CMR groups is associated with a repeater node.

In one embodiment, the processor is configured to feed back a UCI sequence of bits to the network, wherein the UCI sequence of bits comprises information related to one or more of a set of timing advance indicators and a set of UL beam indices corresponding to reference signal resource indicators.

In one embodiment, the processor is configured to receive information related to a set of one or more SRS configurations intended for a set of UE nodes.

A first method is disclosed for repeater-assisted communication. The first method may be performed by a UE as described herein, for example, the remote unit 105 and/or the user equipment apparatus 600. In some embodiments, the first method may be performed by a processor executing program code, for example, a microcontroller, a microprocessor, a CPU, a GPU, an auxiliary processing unit, a FPGA, or the like.

In one embodiment, the first method receives, from a network, an indication of RAC for a repeater apparatus, receives, from the network, configuration information comprising at least one of frequency resources and time resources that the apparatus uses for RAC, receives, from the network, configuration information for reference signals that are transmitted from the network to the apparatus, and determines an indication of one or more UE devices whose transmissions are repeated by the apparatus.

In one embodiment, the indication of RAC is based on configuring a UE with two CORESET pool indices, configuring the UE with two TCI states, configuring the UE with a DCI with a special format that indicates communication between a network node and the apparatus, or some combination thereof.

In one embodiment, the RAC indication based on the two CORESET pool indices also comprises two PDCCHs for the UE in search spaces in the two CORESETs with different CORESET pool index value schedules for a same PDSCH.

In one embodiment, the two PDCCH s or the two search spaces in the two CORESETs with different CORESET pool index values are linked.

In one embodiment, the RAC indication based on two TCI states comprises a first TCI state corresponding to a transmit/receive point network node and a second TCI state corresponding to the apparatus.

In one embodiment, the RAC indication based on the DCI comprises a set of one or more slots, a set of one or more PRBs, a set of one or more BWPs, or a combination thereof.

In one embodiment, fields of the configuration information comprising frequency and time resources that the apparatus uses for RAC comprises a DCI format comprising a carrier indicator, a BWP indicator, a frequency domain resource assignment, a time domain resource assignment, a set of one or more beam indicators, or some combination thereof.

In one embodiment, the first method receives a CSI-RS resource configuration as part of a side control information transmission, the side control information sent on a channel dedicated to a control signaling exchange between a TRP and the apparatus.

In one embodiment, the first method repeats a subset of UE beams in uplink transmission, the subset of UE beams selected based on a threshold with response to one or more of L1-SINR, L1-RSRP, or CQI value.

In one embodiment, a TRP configures the apparatus to forward uplink signals received from a UE based on its corresponding SRS received power.

In one embodiment, the TRP configures the apparatus to forward remaining retransmissions of a PUSCH TB or subsequent uplink transmissions from the UE in response to CRC failing for the PUSCH TB.

In one embodiment, a control information signal is selected from a sequence set corresponding to a pre-defined number of bits, wherein possible sequences that are selected are orthogonal, quasi-orthogonal, pseudo-orthogonal, or some combination of the foregoing.

In one embodiment, the configuration information of reference signals transmitted from the network to the repeater is indicated via one or a combination of DCI, MAC-CE, or higher-layer signaling.

In one embodiment, the apparatus is configured by the network with a CSI reporting setting, a CSI-RS resource setting, a SRS configuration, a timing advance value, or some combination thereof.

In one embodiment, a first SSB RS group is transmitted to the apparatus, and wherein a second SSB RS group is transmitted to one or more UEs.

In one embodiment, the first method receives control information from the network.

In one embodiment, the control information comprises a bitmap, the bitmap comprising a sequence of bits that indicate active resources for the apparatus to transmit, receive, or some combination of both.

In one embodiment, beams in SS/PBCH block resources are decomposed into two subsets of beam groups, wherein a first subset of beams is transmitted from the network and a second subset of beams is transmitted from the apparatus.

In one embodiment, two SS/PBCH block transmission occasions occur, wherein a first SS/PBCH block transmission is transmitted from the network node, and wherein a second SS/PBCH block transmission is transmitted from the apparatus.

In one embodiment, a UE reports indices of a subset of two beams from a set of beams in a SS/PBCH block.

In one embodiment, the RAC is associated with new radio (“NR”) frame structures with extended cyclic prefix.

In one embodiment, the apparatus is configured with a multi-TRP CSI reporting setting for two TRPs, wherein the CSI reporting setting is configured with two CMR groups, and wherein a first of the two CMR groups is associated with a network node, and a second of the two CMR groups is associated with a repeater node.

In one embodiment, the first method feeds back a UCI sequence of bits to the network, wherein the UCI sequence of bits comprises information related to one or more of a set of timing advance indicators and a set of UL beam indices corresponding to reference signal resource indicators.

In one embodiment, the first method receives information related to a set of one or more SRS configurations intended for a set of UE nodes.

A second apparatus is disclosed for repeater-assisted communication. The second apparatus may include a network entity as described herein, for example, the base unit 121, the gNB, and/or the network equipment apparatus 700. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled to the processor. In one embodiment, the processor is configured to cause the apparatus to transmit, to a repeater, an indication of RAC for the apparatus, transmit, to the repeater, configuration information comprising at least one of frequency resources and time resources that the apparatus uses for RAC, transmit, to the repeater, configuration information for reference signals that are transmitted from the repeater to the network, and transmit, to the repeater, an indication of one or more UE devices whose transmissions are repeated by the repeater.

In one embodiment, the processor is configured to configure a UE with a CSI-RS resource configuration corresponding to an NZP CSI-RS resource for interference measurement, or a CSI-IM resource for interference measurement, or a combination thereof, wherein the CSI-RS configuration includes two or more adjacent OFDM symbols in time within a same sub-carrier being pre-empted to enable interference measurement, two or more adjacent sub-carriers within a same OFDM symbol time being pre-empted to enable interference measurement, or some combination thereof.

In one embodiment, the processor is configured to configure a UE with a CSI-RS resource configuration corresponding to an NZP CSI-RS resource for interference measurement, wherein the CSI-RS configuration includes two or more adjacent OFDM symbols in time within a same sub-carrier being transmitted from the repeater to enable interference measurement, two or more adjacent sub-carriers within a same OFDM symbol time being transmitted from the repeater to enable interference measurement, or some combination thereof.

A second method is disclosed for repeater-assisted communication. The second method may be performed by a network entity as described herein, for example, the base unit 121, the gNB, and/or the network equipment apparatus 700. In some embodiments, the second method may be performed by a processor executing program code, for example, a microcontroller, a microprocessor, a CPU, a GPU, an auxiliary processing unit, a FPGA, or the like.

In one embodiment, the second method transmits, to a repeater, an indication of RAC for the apparatus, transmits, to the repeater, configuration information comprising at least one of frequency resources and time resources that the apparatus uses for RAC, transmits, to the repeater, configuration information for reference signals that are transmitted from the repeater to the network, and transmits, to the repeater, an indication of one or more UE devices whose transmissions are repeated by the repeater.

In one embodiment, the second method configures a UE with a CSI-RS resource configuration corresponding to an NZP CSI-RS resource for interference measurement, or a CSI-IM resource for interference measurement, or a combination thereof, wherein the CSI-RS configuration includes two or more adjacent OFDM symbols in time within a same sub-carrier being pre-empted to enable interference measurement, two or more adjacent sub-carriers within a same OFDM symbol time being pre-empted to enable interference measurement, or some combination thereof.

In one embodiment, the second method configures a UE with a CSI-RS resource configuration corresponding to an NZP CSI-RS resource for interference measurement, wherein the CSI-RS configuration includes two or more adjacent OFDM symbols in time within a same sub-carrier being transmitted from the repeater to enable interference measurement, two or more adjacent sub-carriers within a same OFDM symbol time being transmitted from the repeater to enable interference measurement, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor; and
a memory coupled to the processor, the processor configured to cause the apparatus to:
receive, from a network, an indication of repeater-assisted communication (“RAC”) for the apparatus;
receive, from the network, configuration information comprising at least one of frequency resources and time resources that the apparatus uses for RAC;
receive, from the network, configuration information for reference signals that are transmitted from the network to the apparatus; and
determine an indication of one or more user equipment (“UE”) devices whose transmissions are repeated by the apparatus.

2. The apparatus of claim 1, wherein the indication of RAC is based on configuring a UE with two control resource set (“CORESET”) pool indices, configuring the UE with two transmission configuration indicator (“TCI”) states, configuring the UE with a downlink control information (“DCI”) with a special format that indicates communication between a network node and the apparatus, or some combination thereof.

3. The apparatus of claim 2, wherein fields of the configuration information comprising frequency and time resources that the apparatus uses for RAC comprises a DCI format comprising a carrier indicator, a bandwidth part (“BWP”) indicator, a frequency domain resource assignment, a time domain resource assignment, a set of one or more beam indicators, or some combination thereof.

4. The apparatus of claim 3, wherein the processor is configured to receive a channel state information-reference signal (“CSI-RS”) resource configuration as part of a side control information transmission, the side control information sent on a channel dedicated to a control signaling exchange between a transmit/receive point (“TRP”) and the apparatus.

5. The apparatus of claim 3, wherein a control information signal is selected from a sequence set corresponding to a pre-defined number of bits, wherein possible sequences that are selected are orthogonal, quasi-orthogonal, pseudo-orthogonal, or some combination of the foregoing.

6. The apparatus of claim 1, wherein a first signal synchronization block (“SSB”) reference signal (“RS”) group is transmitted to the apparatus, and wherein a second SSB RS group is transmitted to one or more UEs.

7. The apparatus of claim 1, wherein the processor is configured to receive control information from the network, the control information comprises a bitmap, the bitmap comprising a sequence of bits that indicate active resources for the apparatus to transmit, receive, or some combination of both.

8. The apparatus of claim 1, wherein beams in synchronization signal (“SS”)/physical broadcast channel (“PBCH”) block resources are decomposed into two subsets of beam groups, wherein a first subset of beams is transmitted from the network and a second subset of beams is transmitted from the apparatus.

9. The apparatus of claim 1, wherein two synchronization signal (“SS”)/physical broadcast channel (“PBCH”) block transmission occasions occur, wherein a first SS/PBCH block transmission is transmitted from the network node, and wherein a second SS/PBCH block transmission is transmitted from the apparatus.

10. The apparatus of claim 1, wherein a UE reports indices of a subset of two beams from a set of beams in a synchronization signal (“SS”)/physical broadcast channel (“PBCH”) block.

11. The apparatus of claim 1, wherein the RAC is associated with new radio (“NR”) frame structures with extended cyclic prefix.

12. The apparatus of claim 1, wherein the processor is configured to receive information related to a set of one or more sounding reference signal (“SRS”) configurations intended for a set of UE nodes.

13. A method, comprising:
receiving, from a network, an indication of repeater-assisted communication (“RAC”) for a repeater apparatus;
receiving, from the network, configuration information comprising at least one of frequency resources and time resources that the apparatus uses for RAC;
receiving, from the network, configuration information for reference signals that are transmitted from the network to the apparatus; and
determining an indication of one or more user equipment (“UE”) devices whose transmissions are repeated by the apparatus.

14. An apparatus, comprising:
a processor; and
a memory coupled to the processor, the processor configured to cause the apparatus to:
transmit, to a repeater, an indication of repeater-assisted communication (“RAC”) for the apparatus;
transmit, to the repeater, configuration information comprising at least one of frequency resources and time resources that the apparatus uses for RAC;
transmit, to the repeater, configuration information for reference signals that are transmitted from the repeater to the network; and
transmit, to the repeater, an indication of one or more user equipment (“UE”) devices whose transmissions are repeated by the repeater.

15. The apparatus of claim 14, wherein the processor is configured to configure a UE with a channel state information-reference signal (“CSI-RS”) resource configuration corresponding to an non-zero power (“NZP”) CSI-RS resource for interference measurement, or a CSI-interference measurement (“IM”) resource for interference measurement, or a combination thereof, wherein the CSI-RS configuration includes two or more adjacent orthogonal frequency division multiplexing (“OFDM”) symbols in time within a same sub-carrier being pre-empted to enable interference measurement, two or more adjacent sub-carriers within a same OFDM symbol time being pre-empted to enable interference measurement, or some combination thereof.
